(19) United States
(12) Patent Application Publication
(10) Pub. No.: US 2017/0260011 A1
(43) Pub. Date: Sep. 14, 2017

(54) Cartesian Transport Device

(71) Applicant: ANALYTIK JENA AG, Jena (DE)

(72) Inventors: Torsten SCHOEPPE, Jena (DE); Hendrik Drese, Jena (DE); Stephan Hackel, Apolda (DE); Heiko Oehme, Jena (DE)

(21) Appl. No.: 15/069,602

(22) Filed: Mar. 14, 2016

(51) Int. Cl. B65G 47/90; B65G 49/06

(52) U.S. Cl. CPC B65G 47/902; B65G 49/061; B65G 49/062

(57) ABSTRACT

A Cartesian transport device for the transportation of a container plate or a stack of container plates, with a horizontal linear axis, on which a vertical linear axis is arranged such that the plate is movable in the x direction. A transfer unit is arranged on the vertical linear axis such that it is moveable in the z direction. The transfer unit has a support structure and two telescopic arms connected to it and arranged in parallel. A container plate may be grasped and held between the telescopic arms. A horizontal shelf is solidly arranged under the transfer unit on the vertical linear axis between the telescopic arms, such that the container plate may be set down between the telescopic arms.

### FIELD OF THE INVENTION

The invention relates to a Cartesian transport device, as particularly used in laboratories for the transportation of container plates with a standard square surface between different sites on a laboratory table and/or the hand-over positions or transfer positions for laboratory equipment such as stackers, automatic pipetting systems, and incubators.

### BACKGROUND OF THE INVENTION

The container plates to be transported have standard bases, but different heights. This may particularly concern microtiter plates, deep well microtiter plates, tip boxes, carrier frames for tips (tip trays), and carrier frames for tubes (tube racks). To enable the automatic transportation of these container plates between storage sites, processing stations and/or hand-over or transfer positions (hereinafter target positions) with a Cartesian transport device, these target positions are generally preferably arranged along a linear axis in one or more rows for one transport device in the working area, whereby the surface area of the target positions may be of different sizes, but must have at least the surface area of the container plate. The individual target positions, which are organized in rows and preferably in columns, should be characterized for further considerations by their central point, which is defined by Cartesian coordinates. To achieve a short transport path between the target positions, these have been placed close to each other, meaning that there is little free space between the container plates positioned there. An additional difficulty for the transport device is that the container plates have different heights and are stacked in several layers on the storage sites.

To minimize the time needed to process a container plate, only the time needed to transport the container plate between individual target positions can be decreased. Particularly when a container plate is to be transported from one target position that is a storage site to another target position, but is found within a stack of container plates, much time is lost in the unstacking necessary to remove the container plate from the storage site. It is therefore particularly valuable to reduce the time spent in unstacking.

From the application documents WO 2011/151004 A1, a transportation device (handling system) for the handling of particularly plate shaped objects, particularly coated glass plates in the solar and flat screen industry, is known. The handling system has a transfer unit that can move the objects laterally next to various processing stations. For movement along the processing stations, the transfer unit may be moved in a horizontal first direction of travel (x direction). That the transfer unit is also movable in a second, vertical direction of travel (z direction) was not actually necessary for the planned use, but would be simple to solve for a trained professional. The transfer unit has a support structure and two telescopic arms fixed at an interval and arranged in parallel, with which the plate shaped objects, which are broader than the interval between the telescopic arms, are picked up from below and transferred to the carrying element to transport it between the processing stations. The multi-unit telescopic arms are also extendable in a third horizontal direction of travel (y direction) perpendicular to the first two directions of travel to a distance below the objects. There, the objects are picked up on the telescopic arms through a movement in z direction, transferred to the bearing element through a movement in y direction, and finally transported in x direction. The movement in y direction occurs through a linear actuator, which operates simultaneously and uniformly with both telescopic arms and is connected to the support structure and each of the telescopic links. The individual links of the telescopic arms are arranged next to each other in the x direction on a horizontal plane and are in an operative connection with each other and the linear actuator via coupling elements, so that the driving force is transferred to each of the telescopic links. In addition, the coupling elements are ring shaped cables or bands, which are moveably stretched on a telescopic link with two spaced guide rollers, and is connected to the previous and following telescopic link via an attachment point. The moveable connection between the telescopic links is created with guide rails and guide carriages that can be moved on them in a linear fashion.

The rail-like telescopic arms, which are designed for the production line of coated glass plates (photovoltaic module, LCD screens), are correspondingly large and robust. Corresponding to use, no particular requirements are made of the appearance of the bearing element and the telescopic arms.

When the two telescopic arms are fully retracted, both are fully within the base outline under the object being picked up, and the transfer unit can be actuated with the object placed on the retracted telescopic arm in its first direction of travel to bring the object to another processing station. The transport device is not designed to unstack objects that are stacked in layers on processing stations.

### OBJECT OF THE INVENTION

A purpose of the invention is to improve a transport device from the state as known from the above named WO 2011/151004 A1 such that one or multiple simultaneous container plates with standard square bases may be removed from a stack and restacked. The transport paths necessary should be made as short as possible.

This problem is solved with a Cartesian transport device, which is suitable for the transport of a container plate with a square surface. The Cartesian transport device has a horizontal linear axis along the direction of an x axis, on which a vertical linear axis is travelable in the direction of the x axis, and a transfer unit that moves along the vertical linear axis in the direction of an z axis. The transfer unit has a support structure with an outline appropriate for the surface area of the container plate and two telescopic arms placed parallel to each other with an orthogonal spacing. The telescopic arms each have an inner element connected to the support structure, an outer element that is travelable in the direction of the y axis and at least one middle element that is travelable in the direction of the y axis. The inner arm element, the one or more middle arm elements and the outer arm element each have a longitudinal axis, which are organized to move parallel to each other on the vertical level, whereby the outer arm element is under the one or more middle arm elements and the one or more middle arm elements are below the inner arm element. It is a significant invention that a horizontal shelf is present underneath the transfer unit between the inner arm elements and is firmly connected to the vertical linear axis, in such a way that the container plate may be placed on the shelf between the telescopic arms, and the telescopic arms may be placed on top of each other to grip the container plate between the outer arm elements. This may be done with force or positive locking.

To double the working area of the Cartesian transport device, the vertical linear axis is arranged rotationally around the z axis.

It is particularly an aesthetic advantage when the telescopic arms respectively form a casing wall laterally bordering the support structure when in a retracted condition.

To hold the container plate through clamping, a tiltable clamp plate is advantageously positioned on the z direction of each outer arm element, which will connect itself to the container plate by clamping.

The deliverability of the telescopic arms is advantageously realized when the inner arm elements that are connected to the support structure are symmetrically deliverable, for example, elastic, positioned in the x direction, such that the orthogonal distance of the outer arm elements to a path, here also a spring deflection, may be changed, so that these outer arm elements may be brought from a greater orthogonal distance towards each other in an opened position without touching along the container plate, which is organized along the shelf or in the y direction in front of the shelf, and may grip the container plate between them with a small orthogonal distance to each other in a closed position.

It is an advantage when the orthogonal distance between the middle arm elements of the two telescopic arms is greater than the orthogonal distance between the outer aim elements of the two telescopic arms.

For the case that the Cartesian transport device has three degrees of freedom, namely three translational, but not rotational degrees of freedom, it is advantageous if the shelf is formed on a slide, on which the vertical linear axis is firmly connected and with which it is travelable in the x direction.

For the case that it advantageously has a rotational degree of freedom around the z axis, the shelf may advantageously be formed on a rotating table, which is rotationally located on a slide below it.

### BRIEF DESCRIPTION OF THE DRAWINGS

The invention will hereinafter be described more closely on the basis of design examples with the aid of drawings. For this purpose:

FIG. 1 shows the invented transport device with fully retracted telescopic arms,

FIG. 2 shows a transport device in accordance with FIG. 1 with fully extended arms, and

FIG. 3 shows a transportation device with an additional degree of freedom.

### DESCRIPTION OF THE EMBODIMENTS

In the interest of a simplified explanation of the invented device, its technical resources will be described by means of their position and orientation in the working position of the device.

The transport device, as shown in 1, 2, and 3, contains a horizontal linear axis 2, which is oriented in the x direction of a Cartesian coordinate system, and a vertical linear axis 3 oriented horizontally in the z direction for this purpose and travelable along the horizontal linear axis 2 in the x direction.

On the vertical linear axis 3, a transfer unit 4 is positioned such that it can move in the z direction.

The transfer unit 4 has a guide with the vertical linear axis 3 connected to support structure 5, with an outline projected in the x-y plane, conformed to the square surface area of a container plate 1, for which the transport of the transfer unit 4 is dimensioned. On two opposite sides of support structure 5, telescopic arms 6 are affixed with an orthogonal distance a and parallel to each other, which may be retracted and extended in the y direction between a fully retracted and a fully extended condition over a maximal transfer path.

So that the transfer unit 4 may receive a container plate 1 from a laboratory device or a laboratory table on which the transport device is also erected, it is required that container plate 1 is arranged in front of and parallel to, and horizontally along, horizontal linear axis 2. Such a position will hereinafter be designated as the target position. A container plate 1 may only be picked up by a transfer unit 4 from a target position and may be placed on the same or on another target position.

Fundamentally, the target positions may be found in random locations within the working area of the transport device, which is defined by a maximal travel distance of transfer unit 4 along the horizontal linear axis 2 and the vertical linear axis 3 as well as the maximal transfer distance of the telescopic aim 6.

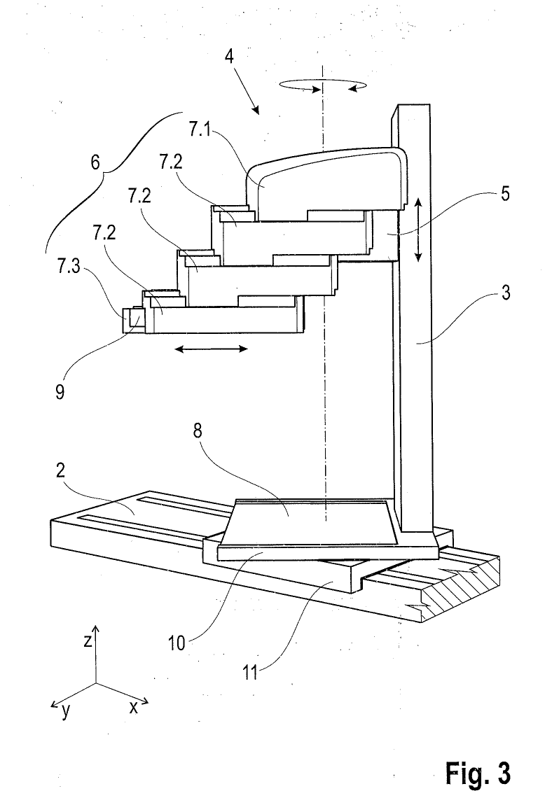

A particularly advantageous execution of the invented transport device is shown in FIG. 3. In addition to the three translational degrees of freedom in x, y, and z directions, this has a rotational degree of freedom around the z axis, in that the vertical linear axis 3 is positioned rotationally around the z axis, whereby the working area, which is otherwise limited to one side along the horizontal linear axis 2, is now contains twice as large an area along both sides of the horizontal linear axis 2.

While in such an execution, the shelf 8 is advantageously formed on slide 11, with which the vertical linear axis may be horizontally moved; shelf 8 is here formed on a rotary table 10, which is placed on top of a rotating slide 11.

For logical reasons, it is not only a single container plate 1 that should be handled with the transport device, but rather multiple container plates 1 simultaneously, which stand in a stack on a laboratory table or form part of such a stack. To pick up and move one part of the stack, hereinafter also called the stack, can for example be of interest when an individual container plate 1, which is in the middle of a stack, is to be transported.

To pick up a single container plate 1 or a stack of container plates 1 with the telescopic arms 6, one container plate 1 at a time- this in the case of a stack with the lowest container plate 1-is grasped over two opposite side walls 1.1 between the telescopic aims 6. In this way, container plate 1 may be grasped and held with force fitting or positive locking.

For the handling and storage of the container plates 1, these will be arranged on a laboratory table in a relatively small area, preferably in two or possibly in three horizontal linear axis 2 parallel rows next to or when appropriate, behind each other, within a small distance of each other. So that the telescopic arms 6 may be extended between two neighboring stacks without hindrance, the telescopic arms 6 should be small in their dimension b_{T} in the direction of the x axis.

The telescopic arms 6 each have an inner arm element 7.1 connected with support structure 5, at least one middle arm element 7.2 and an outer arm element 7.3. The one or more middle arm elements 7.2 and the single outer arm element 7.3 may be moved to each other and towards the inner arm element 7.1 in the y direction. The inner arm element 7.1, the one or more middle arm elements 7.2 and the outer arm element 7.3, hereinafter designated as arm elements 7.1, 7.2, 7.3, each have a longitudinal axis 7.0. The longitudinal axes 7.0 of the arm elements 7.1, 7.2, 7.3 of a telescopic arm 6 are each arranged parallel to each other in a vertical plane E. It is advantageous for the outer surfaces of the arm elements 7.1, 7.2, 7.3 in a fully retracted condition of the telescopic arms to respectively form a casing wall of transfer unit 4 laterally on support structure 5.

With regard to the vertical linear axis 3, the uppermost of the arm elements 7.1, 7.2, 7.3 are the inner arm elements 7.1, which are connected with support structure 5. They are only adjustable towards the support structure 5 with a small adjustment track, so that telescopic arms 6 may be moved between the open and closed position. The one or more moveable middle arm element 7.2 is placed vertically under the inner arm element 7.1 and above the outer aim element 7.3, so that the outer arm element 7.3, which forms the free end of the telescopic arm 6, is the lowest of the arm elements 7.1, 7.2, 7.3. Between the two lowest of the arm elements 7.1, 7.2, 7.3, namely the outer arm elements 7.3, the container plate 1 is held clasped and clamped, while the telescopic arms 6 may be moved between the fully extended and retracted condition in the y direction, and the transfer unit 4 can be moved along the vertical linear axis 3 in the z direction and the vertical linear axis 3 can be moved along the horizontal linear axis 2 in the x direction. In this way, container plate 1 may be picked up and deposited into every target position in the working area of the transport device.

It is a significant feature of the invention that there is a horizontal shelf 8 rigidly connected to the vertical linear axis 3 between the telescopic arms 6 underneath transfer unit 4, so that container plate 1 or a stack of container plates 1 may also be distributed between the telescopic arms 6. The shelf 8 is thus an additional target position with a particular use. The particular use consists of the fact that a container plate 1 or a stack of container plates 1 may be stored in the interim and may during this time be transported with transfer unit 4 in the x direction. When, for example, the fifth container plate 1 from the bottom in a stack of ten container plates 1 is to be transported to a target position, which is, for example, under a pipetting head, a stack of five container plates 1 is picked up, in that the sixth container plate from the bottom is gripped and clamped, and then placed on shelf 8. Then the fifth container plate 1 from the bottom, which in now on the top, is gripped individually, clamped, transported to the target location and placed there. When a transportation movement in the x direction is necessary for the achievement for a target location, the stack of container plates 1 standing on shelf 8 travels with it. Finally, the stack of container plates 1 is transported back in the reverse direction and placed back on the remaining stack of container plates 1. Shelf 8 offers an additional target location, which always moves with transfer unit 4 and is therefore always close to a target location from which container plate 1 or a stack of container plates 1 may be taken or upon which these may be placed. With this, the transport paths particularly for restacking processes are made shorter and time is perforce saved.

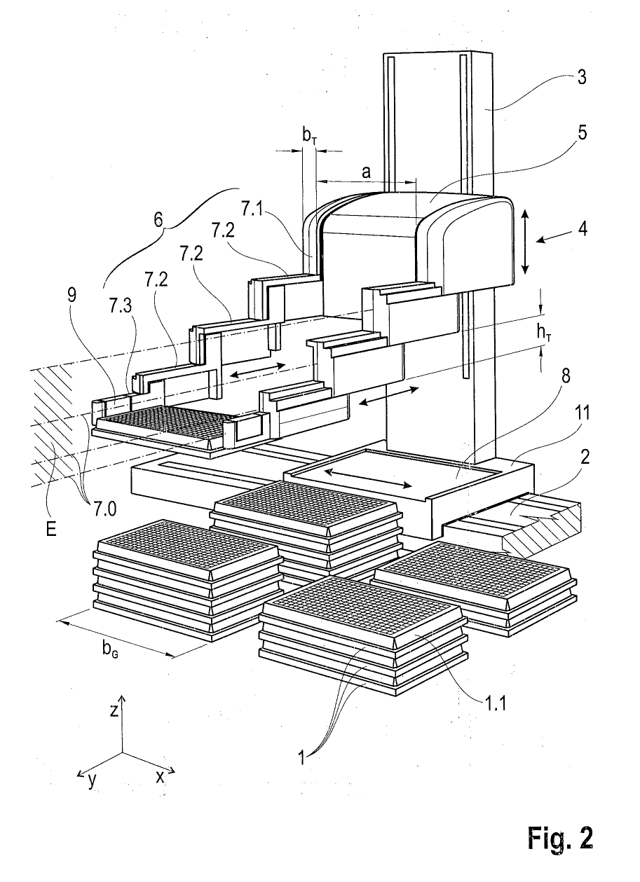

It is advantageous for the orthogonal distance a between the telescopic arms 6 in the area of the outer arm element 7.3 to be less than that between the middle arm elements 7.2. This makes it possible to grasp, clamp, and transport a container plate 1 that is farther from the horizontal linear axis 2 past a container plate 1 or a stack of container plates 1, as is recognizable from FIG. 2.

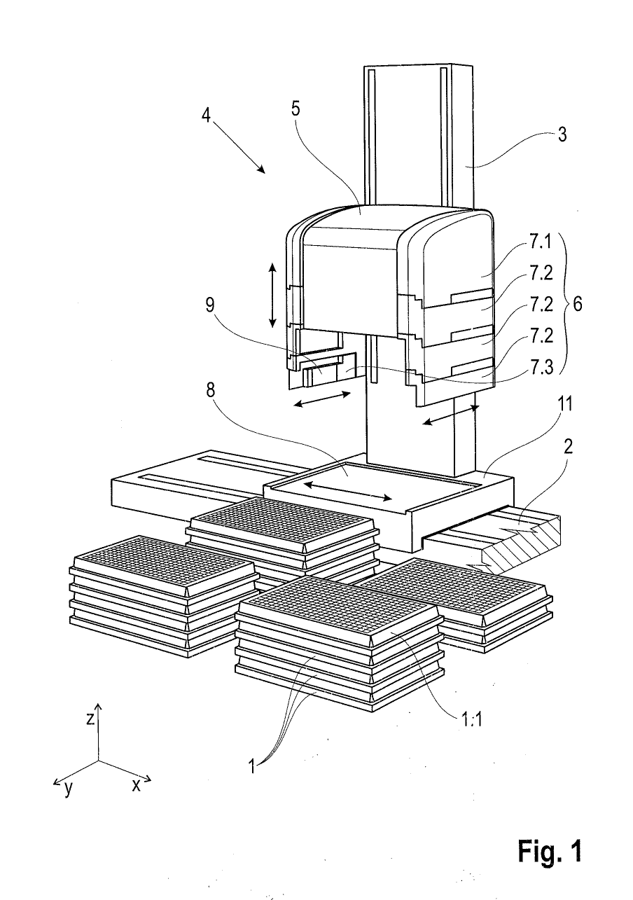

In that the longitudinal axes 7.0 of the arm elements 7.1, 7.2, 7.3 of the telescopic arm are each arranged in the common vertical plane E and it is advantageous for all moveable aim elements 7.2, 7.3 of the telescopic arms 6 to have a breadth b_{T} perpendicularly to their longitudinal axis 7.0, which is smaller or the same width as the inner arm element 7.1 connected with the support structure, the telescopic arms 6 only need a small amount of room to extend. The width may be elected to be smaller, such that the necessary bending stiffness of the individual arm elements 7.1, 7.2, 7.3 are won over a comparatively greater height h_{T}. It is advantageous for each of the inner arm elements 7.1 and the one or more middle arm elements 7.2, to form a hollow and for guiding elements of a neighboring arm element 7.2, 7.3, such as a slide, to be integrated into the hollow area formed, so that this guiding element has no effect on the breadth b_{T} of the telescopic arms. The transport direction depicted in FIGS. 1, 2, and 3, as they have been generally described previously, have telescopic arms 6, each having three middle aim elements 7.2. To raise the travel path of a telescopic arm 6 without changing the number of middle arm elements 7.2, the height h_{T} or the breadth b_{T} may be increased. The expansion of the height h_{T} would, to enable an unchanged maximal transport path in a vertical direction, require a larger installation space for the vertical linear axis 3. A larger breadth b_{T} would require that two stacks of container plates 1 arranged on neighboring target locations in an x direction must have a greater distance from each other. For a larger transport path, the length of the middle arm element 7.2 may also be elongated, but, to avoid decreasing their bending stiffness in the otherwise unchanged dimensioning, it is preferable to increase the number of middle are elements 7.2.

In FIG. 1, four target locations are shown, which are here arranged in two rows and two columns

It is advantageous to arrange a clamp plate 9 tiltable in the z direction to each outer arm element 7.3, which attached to container plate 1 in by clamping. The possibility of tilting can be very simply achieved with a tilt axis in the z direction and a large fixture around the clamped tilting axis.

So that the telescopic arms 6 and thus the inner arm element 7.1 are deliverable (i.e., extendable or moveable) to the support structure 5, these are clamped symmetrically across from the support structure 5 in an implementation of the transport device in the x direction. The telescopic arms 6 may be brought to two end positions as viewed across from support structure 5 in the x direction, such that they may be brought to an end position past the container plate 1 to grasp and hold this in another end position. The path between the end positions is determined by the delivery path, which, in the case of a springy support is also the spring deflection. In one end position, the orthogonal distance a of the outer arm element 7.3 of the telescopic arm 6 is greater than the breadth b_{G} of the container plate 1 and the telescopic arms 6 are in an open position, such that they may be lead without contact along the container plate 1, which lies on shelf 8 or in the y direction in front of shelf 8 in a target position. In another end position, the orthogonal distance a of the outer arm element 7.3 of the telescopic arm 6 is the same as the breadth b_{G} of the container plate 1. The telescopic arm 6 is in a closed position and clamps the container plate 1 between itself or is in a form fit between the outer arm element 7.3 and the container plate 1.

The orthogonal distance a between the three middle arm elements 7.2 of the two telescopic arms 6 is preferably greater than the orthogonal distance a of the outer arm elements 7.3 of the two telescopic arms 6. In this way, the transfer unit 4 may grasp a stack of container plates 1 with the outer aim elements 7.3 unhindered by a stack of container plates 1 standing between the middle arm elements 7.2, and may lift and transport these above the other stack of container plates 1.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE LIST

1 container plates

1.1 side wall (of container plate 1)

2 horizontal linear axis

3 vertical linear axis

4 transfer unit

5 support structure

6 telescopic arm

7.0 longitudinal axis (of the arm elements 7.1, 7.2, 7.3)

7.1 inner arm element (of the arm elements)

7.2 middle arm element (of the arm elements)

7.3 outer arm element (of the arm elements)

8 shelf

9 clamp plate

10 rotary table

11 slide

a orthogonal distance between the telescopic arms 6

b_{G} breadth (of the container plate 1)

b_{T} breadth (of the telescopic arm 6)

h_{T} height (of the telescopic arm 6)

E plane

What is claimed is:

1. A Cartesian transport device for the transportation of a container plate comprising a square base, said transport device having a horizontal linear axis arranged in the direction of an x axis, a vertical linear axis being moveably arranged on the horizontal linear axis in the direction of the x axis, and a transfer unit which is moveably arranged on the vertical linear axis in the direction of a z axis, said transfer unit including a support structure with an outline conforming to the base of the container plate and two telescopic arms arranged in parallel with each other at an orthogonal distance from each other, each of said telescopic arms having an inner arm element being connected to said support structure, an outer arm element which is moveable in the direction of a y axis, and at least one middle arm element that is moveable in the direction of the y axis, said inner arm element, said at least one middle arm element, and said outer arm element each having a longitudinal axis, said longitudinal axes being arranged parallel and offset to each other in a vertical plane, the outer arm element being arranged under the at least one middle arm element, and the at least one middle arm element being arranged under the inner arm element, and a horizontal shelf being provided under the transfer unit between the inner arm elements, said horizontal shelf being firmly connected to said vertical linear axis, so that the container plate between the telescopic arms may be set on the shelf, and the telescopic arms being movable toward each other to grip the container plate between the outer arm elements.

2. The Cartesian transport device according to claim 1, wherein the vertical linear axis is housed rotationally around the z axis.

3. The Cartesian transport device according to claim 1, wherein the telescopic arms form a casing wall laterally on the support structure in a retracted condition.

4. The Cartesian transport device according to claim 1, further comprising a clamp plate arranged so as to be tiltable about the z direction located on each of the outer arm elements, said clamp plate being attached to the container plate in clamping.

5. The Cartesian transport device according to claim 1, wherein the deliverability of the telescopic arms is realized by the inner arm elements, which are connected with the support structure, being mounted so as to be symmetrically deliverable in the x direction, so that the orthogonal distance of the outer arm elements may be changed by a delivery path, so that said outer arm elements may be guided with no contact along the container plate with a greater orthogonal distance to each other in an open position, the container plate being arranged on the shelf or in the direction of the y axis in front of the shelf, and may grip the container plate between them with a smaller orthogonal distance to each other in a closed position.

6. The Cartesian transport device according to claim 2, wherein the deliverability of the telescopic arms is realized by the inner arm elements, which are connected to the support structure, being mounted so as to be symmetrically deliverable in the x direction, so that the orthogonal distance of the outer arm elements may be changed by a delivery path, so that said outer arm elements may be guided with no contact along the container plate with a greater orthogonal distance to each other in an open position, the container plate being arranged on the shelf or in the direction of the y axis in front of the shelf, and may grip the container plate between them in a closed position with a smaller orthogonal distance to each other.

7. The Cartesian transport device according to claim 5, wherein the orthogonal distance between the middle arm elements of the two telescopic arms is greater than the orthogonal distance between the outer arm elements of the two telescopic arms.

8. The Cartesian transport device according to claim 6, wherein the orthogonal distance between the middle arm elements of the two telescopic arms is greater than the orthogonal distance between the outer arm elements of the two telescopic arms.

9. The Cartesian transport device according to claim 1, wherein said shelf is formed on a slide with which the vertical linear axis is moveable in a guided manner in the direction of the x axis.

10. The Cartesian transport device according to claim 2, wherein said shelf is formed on a rotary table which is rotationally positioned in a slide located below the rotary table, the vertical linear axis being movable in a guided manner in the direction of the x axis with said slide.
